(19) United States
(12) Patent Application Publication
(10) Pub. No.: US 2001/0028565 A1
(43) Pub. Date: Oct. 11, 2001

(54) Head light system for vehicle

(76) Inventor: Hiroyuki Ishida, Shizuoka-ken (JP)

Correspondence Address: Jonathan P. Osha, ROSENTHAL & OSHA L. L. P., 700 Louisiana Street, Suite 4550, Houston, TX, 77002, US

(21) Appl. No.: 09/819,271

(22) Filed: Mar. 28, 2001

(30) Foreign Application Priority Data
Mar. 28, 2000 (JP) 2000-88099

(51) Int. Cl. B60Q 1/14

(52) U.S. Cl. 362/464; 362/295; 315/81

(57) ABSTRACT

A head light system for controlling a distribution pattern based on a vehicle condition, includes: alight set having a variable irradiation intensity; a lamp body accommodating the light unit; and a control unit for controlling, based on the condition of the vehicle, the irradiation intensity of the light set while the control unit keeps on the light set in a turn-on status.

This patent application claims priority from a Japanese patent application No. 2000-088099 filed on Mar. 28, 2000, the contents of which are incorporated herein by reference.

### BACKGROUND OF THE INVENTION

1. Field of the Invention

The present invention relates to a head light system for a vehicle. More particularly, the present invention relates to what is called a multiple light head light system for a vehicle.

2. Description of the Related Art

A head light system for a vehicle is constructed selectively switchable from a low beam distribution pattern to a high beam distribution pattern one another. Applying the head light system for a vehicle of which configuration of each of these distribution pattern is fixed, it is difficult to irradiate beams with an effectual distribution pattern corresponding to a driving situation of the vehicle.

Conventionally, as disclosed in Japanese Utility Model Publication No. Hei. 2-17364, for example, a head light system for a vehicle enables to irradiate beams with distribution patterns corresponding to the driving condition of a vehicle such that a plurality of light units which irradiate beams forward to the vehicle with a predetermined distribution pattern are accommodated inside a lamp body, and these light units in a suitable combination are turned on corresponding to the driving condition of the vehicle.

In other case, in Japanese Patent Application Laying-Open No. Hei. 11-45606, a head light system for a vehicle, which is constructed that its irradiation intensity of each of the light units accommodated inside the lamp body is adjustable for the driver's manual operation, is proposed.

The above described conventional head light system, however, includes a problem such that a part of the light units are turned off and on again according to the driving condition of the vehicle, so that it may bother a driver of oncoming car and a pedestrian with strangeness such that they falsely recognize that a passing operation is performed.

Furthermore, in some driving condition of the vehicle, it also includes a problem such that a part of the light units are in turn-off status so that inside the lamp body looks partially dark. Therefore, an appearance of the light is impaired.

### SUMMARY OF THE INVENTION

The present invention of the application is aim to achieve the above described object by contrive an irradiation control method for a plurality units accommodated in a lamp body.

More specifically, an object of the present invention is to provide ahead light system for a vehicle which enables to prevent bothering a driver of an oncoming car and so on with strangeness and also to prevent damage on an appearance of light.

A first aspect of the present invention provides with a head light system for controlling a distribution pattern based on a vehicle condition, comprising: a light set having a variable irradiation intensity; a lamp body accommodating the light unit; and a control unit for controlling, based on the condition of the vehicle, the irradiation intensity of the light set while the control unit keeps on the light set in a turn-on status.

A second aspect of the present invention provides with a method for controlling a head light set for a vehicle, comprising the steps of: dividing a vehicle condition into a first region, a second region and a third region; in the first region, maintaining an irradiation intensity of the head light set at a first intensity; in the third region, maintaining the irradiation intensity of the head light set at a third intensity being different from the first intensity; in the second region, controlling the irradiation intensity of the head light set at a second intensity between the first intensity and the third intensity; and maintaining the head light set in a turn-on status among the first region, the second region and the third region.

Detailed constructions of a “light set” and “light units” are not particularly limited. It may be a so-called parabola type light unit or a so-called projector type light unit. Detailed constructions of light source of the above described “light units” are also not particularly limited. It may be a discharge luminescent unit of a discharge bulb or a filament of an incandescent bulb such as a halogen bulb.

“Distributionpatterns” formed by each of the above described light units may be various distribution patterns different from each other or distribution patterns having similar distribution patterns.

In above described intensity control, a detailed method for “controlling irradiation intensity” is not particularly limited. The supply power to light source of the light unit maybe controlled. Alternately, a plurality of light source may be provided in one light unit and the light source turned on is switched, or a part of its light sources may be turned on and off. On the other hand, this “irradiation control” may be operated with properly selected various factors indicating driving conditions of the vehicle such as speed, a rudder angle, and navigation information and so on.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows configuration of a head light system for a vehicle applying a first embodiment of the present invention.

FIG. 2 shows a front view of the light set of the first embodiment.

FIGS. 3A to 3D show distribution patterns formed by the respective light units of the above described light set.

FIGS. 4A and 4B show distribution patterns irradiating from the above described light set forward to the vehicle when the vehicle goes straight.

FIGS. 5A and 5B show distribution patterns irradiating from the above described light set to forward the vehicle when the vehicle turns to the left.

FIGS. 6A and 6B show distribution patterns irradiating from the above described light set to forward of the vehicle when the vehicle turns to the right.

FIG. 7 shows an intensity control pattern of the first embodiment.

FIG. 8 shows configuration of ahead light system for a vehicle applying a second embodiment of the present invention.

FIG. 9 shows a front view of the light set of the above described second embodiment.

FIGS. 10A to 10E show distribution patterns formed by the respective light units of the above described light set.

FIG. 11A and 11B show distribution patterns irradiating from the above described light set to forward of the vehicle when the vehicle drives at low speed.

FIGS. 12A and 12B show distribution patterns irradiating from the above described light set to forward of the vehicle when the vehicle drives at high speed.

FIG. 13 shows an intensity control pattern of the second embodiment.

FIG. 14 shows configuration of a head light system for a vehicle applying the third embodiment of the present invention.

FIG. 15 shows a front view of the light set of the above described third embodiment.

FIGS. 16A to 16C show how each of the light units of the above described light set turns on watching from the direction facing to front of the vehicle.

FIG. 17 shows an intensity control pattern of the third embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

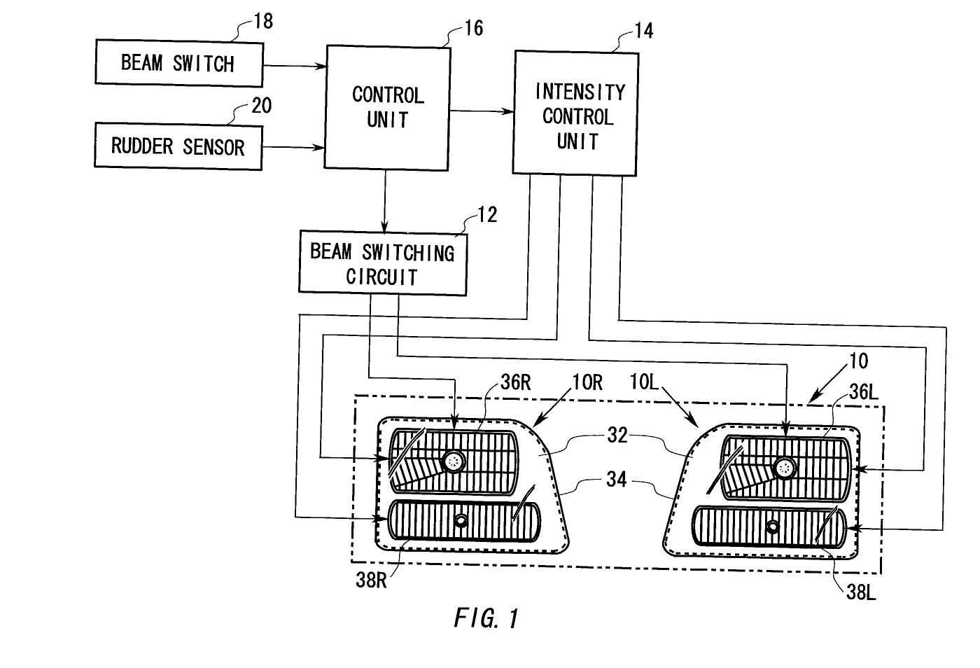

First, a first embodiment of the present invention will be described. FIG. 1 shows an outline configuration of a head light system for vehicles according to the first embodiment of the present invention.

The head light system of the present embodiment for vehicles has a light set 10 which includes a bilateral pair of head light 10L and 10R provided on the front end of a vehicle, abeam switching circuit 12, an intensity control unit 14, a control unit 16, a beam switch 18, and a rudder sensor 20.

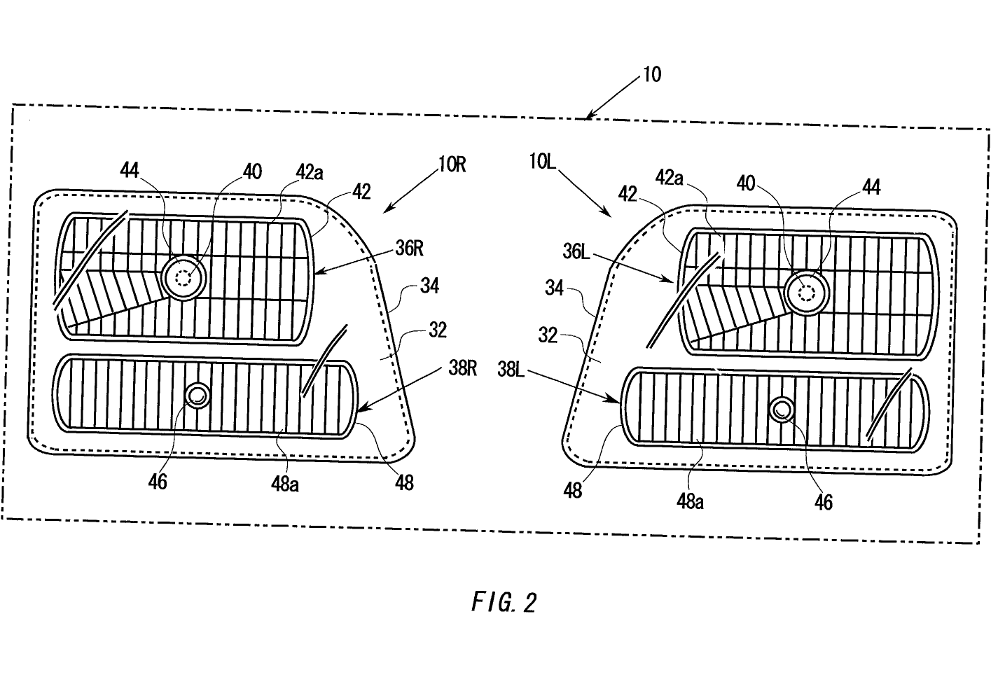

As shown in FIG. 2, the above described light set 10 has head lights 10L and 10R. For each of the head lights 10L and 10R, first light units 36L and 36R and second light units 38L and 38R are provided in a lamp room which is formed with a plain clear cover 32 and a lamp body 34, interjected with an aiming mechanism. The aiming mechanism enables to tilt the first light units 36L and 36R and the second light units 38L and 38R in the vertical direction and in the horizontal direction.

Each of the above described first light units 36L and 36R includes an H4 type (double filament type) halogen bulb 40, a reflector 42, and a shade 44.

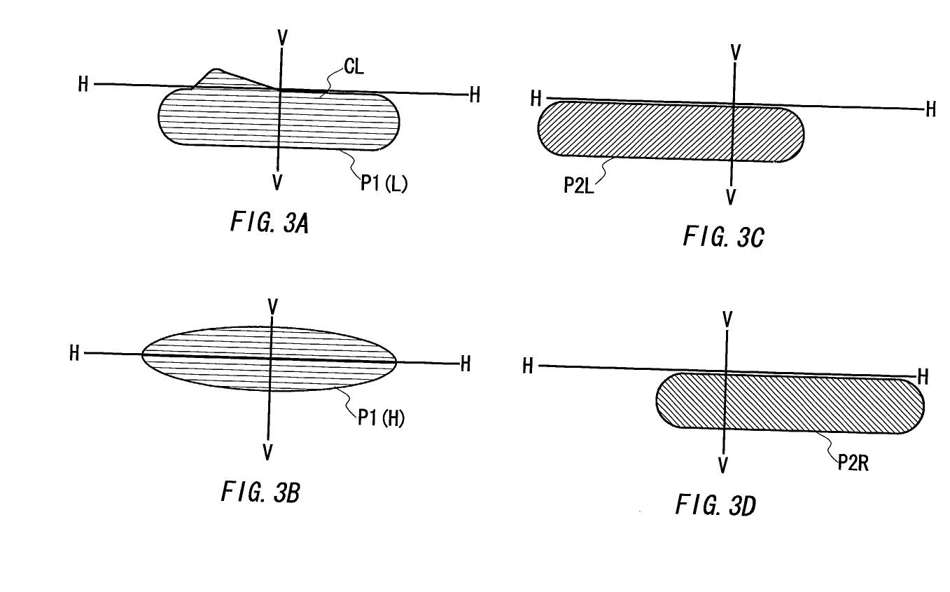

Each of the above described reflector 42 has a reflection surface 42a which is formed with a paraboloid of revolution as a reference surface. Using this reflection surfaces 42a, light from light sources of the halogen bulbs 40 (filaments for low beams or filaments for high beams) is reflected forward with diffusing and deviating; so that it irradiates beams forward to the vehicle with a predetermined distribution pattern. That is, when the above described filaments for low beams are turned on, a distribution pattern for low beams P1(L) which has a cut off line CL shown in FIG. 3A are formed. When the above described filaments for high beams are turned on, a distribution pattern for high beams P1(H) shown in FIG. 3B are formed.

On the other hand, each of the above described second light units 38L and 38R includes an H7 type (single filament type) halogen bulb 46 and a reflector 48.

Each of the reflector 48 described above has a reflection surface 48a which is formed with a paraboloid of revolution as a reference surface. Using this reflection surface 48a, light from a light source of the halogen bulb 46 (filament) is reflected forward with diffusing and deviating; so that it irradiates beams forward to the vehicle with a predetermined distribution pattern. That is, the second light unit 38L of the left head light 10L forms a left irradiating pattern P2L shown in FIG. 3C, and the second light unit 38R of the right head light 10R forms a right irradiating pattern P2R shown in FIG. 3D.

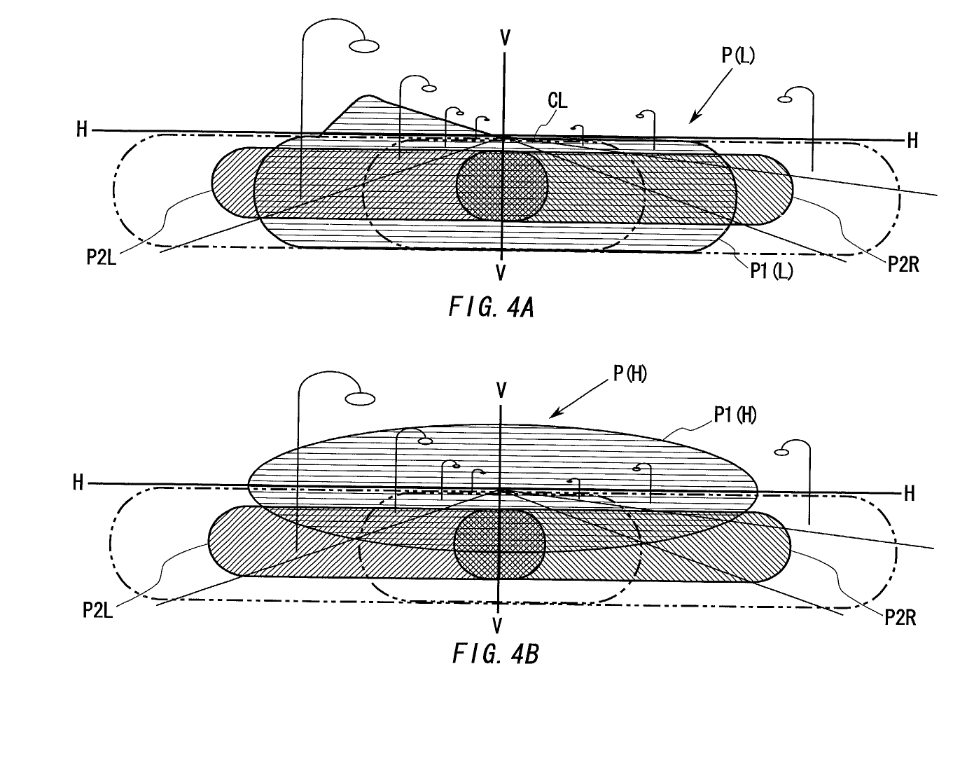

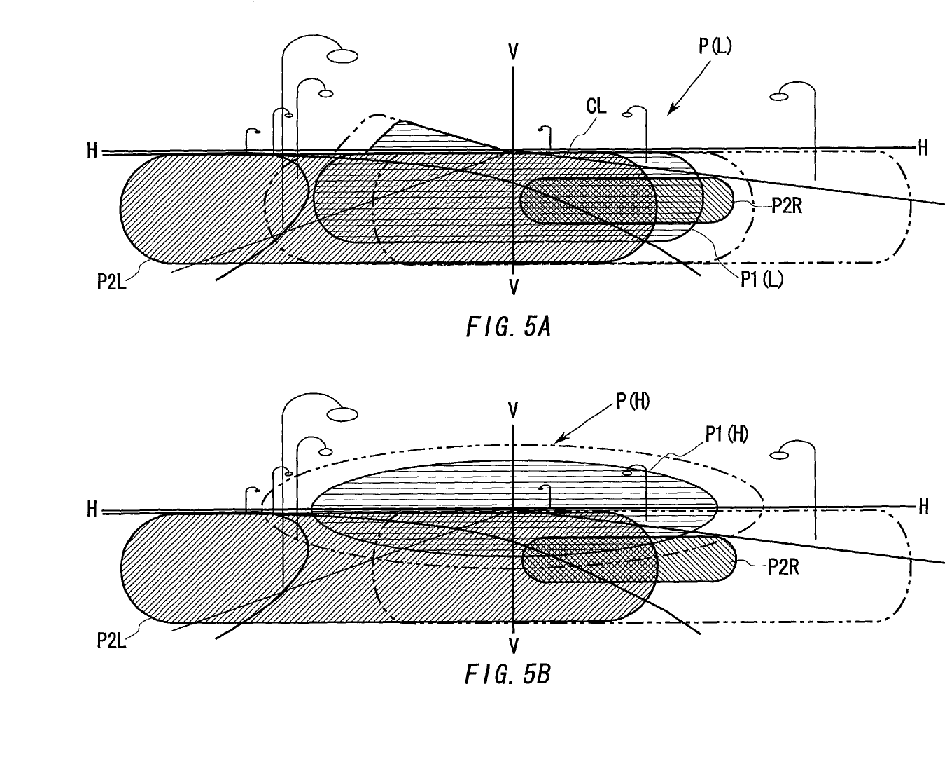

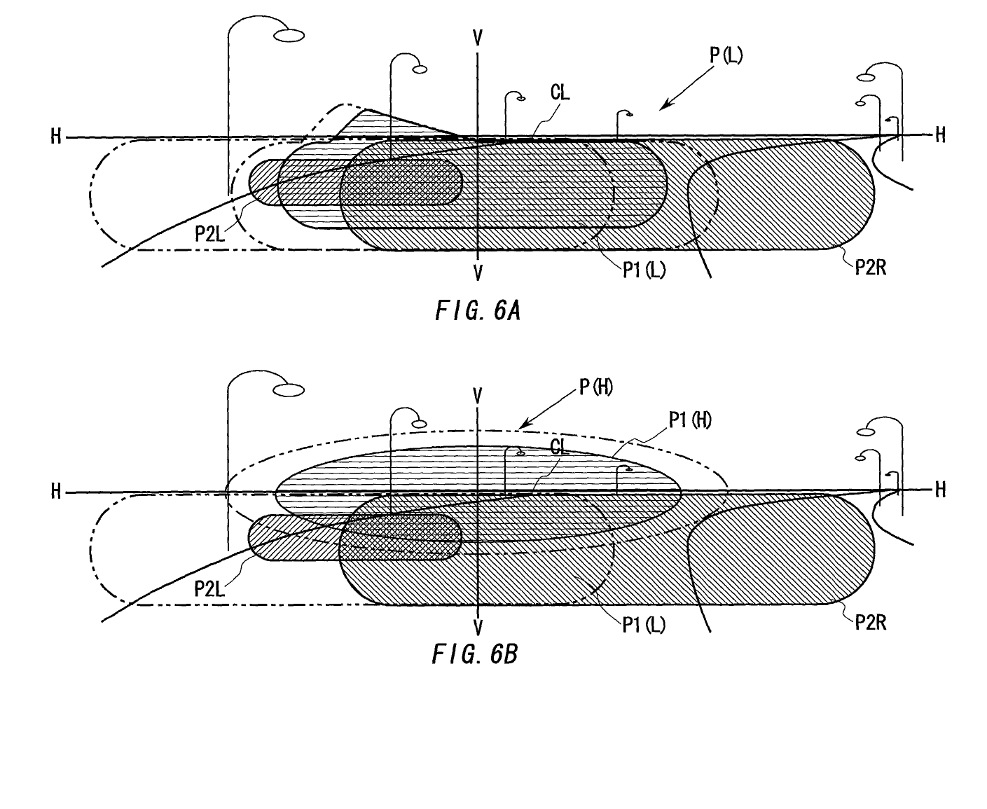

FIGS. 4A to 6B show distribution patterns irradiating forward to a vehicle from the above described light set 10. FIGS. 4A and 4B show distribution patterns when the vehicle goes straight, FIGS. 5A and 5B show distribution patterns when the vehicle turns to the left, and FIGS. 6A and 6B show distribution patterns when the vehicle turns to the right. FIGS. 4A, 5A and 6A show low beam distribution patterns and FIGS. 4B, 5B and 6B show high beam distribution patterns.

As shown in these figures, the low beam distribution pattern P (L) is formed by a superposition of a distribution pattern for a low beam distribution pattern P1(L) by the first light units 36L and 36R, a left irradiating pattern P2L by the left second light unit 38L, and a right irradiating pattern P2R by the right second light unit 38R. On the other hand, the high beam distribution pattern P(H) is formed by a superposition of a distribution pattern for a high beam P1(H) by the above described first light units 36L and 36R, a left irradiating pattern P2L by the left second light unit 38L, and a right irradiating pattern P2R by the right second light unit 38R.

In the present embodiment, the first light units 36L and 36R construct a straight ahead irradiating unit which irradiates a main part of the low beam distribution pattern P(L) and high beam distribution pattern P(H). The left second light unit 38L constructs a left irradiating unit which irradiates to reinforce the left of the above described main part. The right second light unit 38R constructs a right irradiating unit which irradiates to reinforce the right of the above described main part.

In the present embodiment, however, as obviously shown in FIGS. 4A to 6B, each of the above described light units 36L, 36R, 38L, and 38R does not always irradiate at the rated power. Intensity control is operated in order to control the irradiation intensity of each of the light units 36L, 36R, 38L, and 38R; so that the irradiation is controlled corresponding to a rudder angle.

This irradiation control corresponding to the rudder angle is operated as follows. As shown in FIG. 1, a beam switch 18 selectively switches the low beam distribution pattern and the high beam distribution pattern. The beam switching signal from the beam switch 18 and a rudder signal detected from the rudder sensor 20 are inputted to the control unit 16. This control unit 16 outputs the beam switching signal to the beam switching circuit 12 and also outputs an intensity control signal corresponding to the rudder angle to the intensity control unit 14.

The beam switching circuit 12 switches both of the light units 36L and 36R according to the beam switching signal from the control unit 16. The intensity control unit 14, based on the control signal for the intensity control from the control unit 16, controls the power supply continuously variable to each of the light units 36L, 36R, 38L, and 38R using a duty control and so on; and the irradiation intensity of each of the light units 36L, 36R, 38L, and 38R is adjusted.

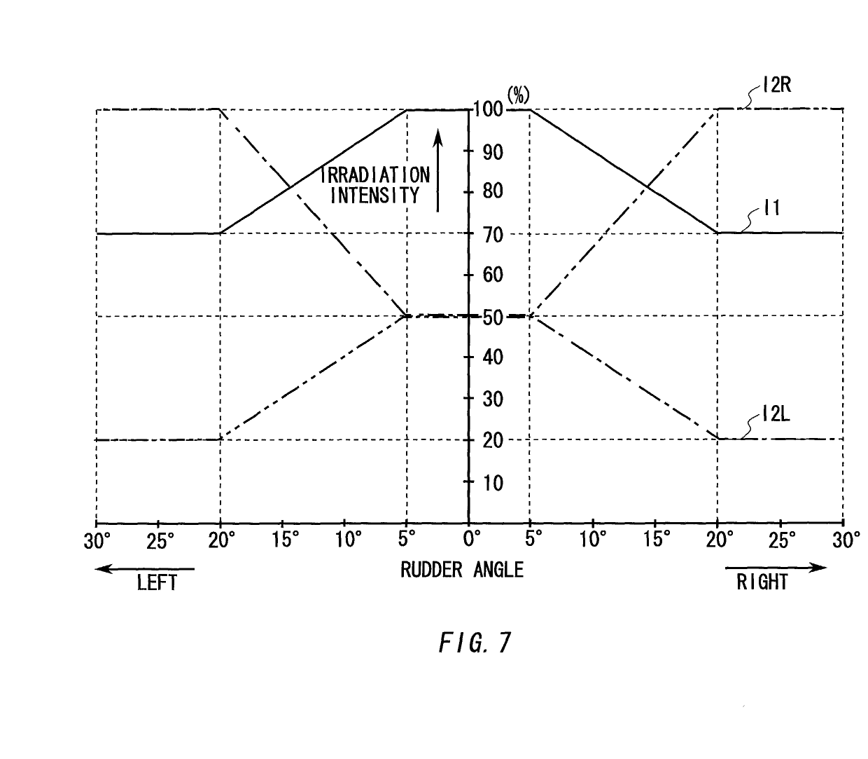

FIG. 7 shows an intensity control pattern of the present embodiment. When the vehicle goes straight with rudder angle 0, the power supply to each of the first light units 36L and 36R as a straight ahead irradiating units is set the same value as the rated power. Namely, its irradiation intensity I1 become maximum. The power supply to the second light unit 38L as the left irradiating unit and the second light unit 38R as the right irradiating unit is set a smaller value than the rated power such that their irradiation intensity I2L and I2R are 50% of the maximum value.

Under this condition, a distribution pattern irradiated from the light set 10 forward to the vehicle is shown in either FIG. 4A or 4B. That is, P1(L) and P1(H), which are formed by the first light units 36L and 36R which irradiate the main part of the low beam distribution pattern P(L) and the high beam distribution pattern P (H), are the same as the distribution pattern shown in FIGS. 3A and 3B. In contrast, the left irradiating pattern P2L and the right irradiating pattern P2R, which are formed by the second light unit 38L which irradiates to reinforce the left of the above described main part and the second light unit 38R which irradiates to reinforce the right of the above described main part, become smaller distribution patterns than the patterns shown in the FIGS. 3C and 3D, which are indicated with chain double dashed lines in FIGS. 4A and 4B. Thus, when the vehicle goes straight, the front forward to the vehicle is irradiated with adequate intensity and moderately widely.

On the other hand, when the vehicle turns to the left in the large rudder angle over 20 degree, the power supply to the first light units 36L and 36R as the straight ahead irradiating units is set a smaller value than the rated power such that its irradiation intensity I1 becomes 70% of the maximum value. Under this circumstance, the power supply to the second light unit 38L as the left irradiating unit is set the same as the rated power such that its irradiation intensity I2L becomes the maximum value. Contrary, the power supply to the second light unit 38R as the right irradiating unit is set a smaller value than the rated power such that its irradiation intensity I2R becomes 20% of the maximum value.

Under this circumstance, the distribution pattern irradiated from the light set 10 forward to the vehicle is shown either FIG. 5A or 5B. That is, a left irradiating pattern P2L formed by the second light unit 38L irradiating left front of the vehicle is the same irradiating pattern as shown in FIG. 3C. In contrast, a right irradiating pattern P2R formed by the second light unit 38R irradiating right front of the vehicle is quite smaller distribution pattern than the pattern shown in FIG. 3D, being indicated with chain double dashed lines in FIGS. 5A and 5B. The distribution pattern for a low beam P1(L) and the distribution pattern for a high beam P1(H), irradiating straight forward to the vehicle formed by the first light units 36L and 36R, also become smaller distribution patterns than the pattern shown in FIGS. 3A and 3B, being indicated with chain double dashed lines in FIGS. 5A and 5B.

Thus, when the vehicle turns to the left, the left front of the vehicle as the vehicle's traveling direction is irradiated with the adequate irradiation intensity. On the other hand, the irradiation intensity to the front right of the vehicle having much less relation with the vehicle's traveling direction is significantly reduced, and the irradiation intensity to the straight front of the vehicle having less relation with the vehicle's traveling direction is also reduced a little. Therefore, the power supply does not exceed the power when the vehicle goes straight too much.

On the contrary, when the vehicle turns to the right in the large rudder angle over 20 degree, supply power to each of the light units 36L, 36R, 38L, and 38R is the same as when the vehicle turns to the left in the large rudder angle over 20 degree, except for trading place of the power supply to the second light unit 38L and the second light unit 38L as the left irradiating unit with that of the second light unit 38R as the right irradiating unit.

FIGS. 6A and 6B show the distribution patterns irradiate forward to the vehicle from the light set 10 under this condition. The distribution pattern for a low beam P1(L) and the distribution pattern for a high beam P1(H) is the same as the distribution pattern shown in FIGS. 5A and 5B, respectively. The left irradiating pattern P2L and right irradiating pattern P2R are bilaterally symmetrical to the distribution pattern shown in FIGS. 5A and 5B.

Thus, when the vehicle turns to the right, the right front of the vehicle as the vehicle's traveling direction is irradiated with the adequate irradiation intensity. On the other hand, the irradiation intensity to the front left of the vehicle having much less relation with the vehicle's traveling direction is significantly reduced, and the irradiation intensity to the straight ahead of the vehicle having less relation with the vehicle's traveling direction is reduced a little. Thus, it does not consume much larger power than when the vehicle goes straight.

Even the vehicle is turning, in small rudder angle region with the rudder angle less than 5 degree, the same distribution pattern as when the vehicle goes straight has no special problem. Therefore, the power supply to each of the light units 36L, 36R, 38L, and 38R is set the same value as when the vehicle goes straight. This improves the stabilization of the control.

In the middle rudder angle region from 5 degree to 20 degree, the power supply is controlled in quantity corresponding to the rudder angle, as follows. That is, as shown in FIG. 7, the power supply to each of the first light units 36L and 36R as the straight ahead irradiating units is gradually reduced as the rudder angle increases. In this embodiment, its irradiation intensity I1 is gradually reduced from 100% to 70%. To the second light unit 38L as the left irradiating unit, when the vehicle turns to the left, the power supply is gradually increased corresponding to the rudder angle is increased, such that its irradiation intensity I2L is gradually increased from 50% to 100%. When the vehicle turns to the right, the power supply to the left second light unit 38L is gradually decreased corresponding to the rudder angle is increased, such that its irradiation intensity I2L is gradually decreased from 50% to 20%. On the contrary, to the second light unit 38R as the right irradiating unit, when the vehicle turns to the right, the power supply is gradually increased corresponding to the rudder angle is increased, such that its irradiation intensity I2R is gradually increased from 50% to 100%. When the vehicle turns to the left, the power supply to the right second light unit 38R is gradually decreased corresponding to the rudder angle is increased, such that its irradiation intensity I2R is gradually decreased from 50% to 20%.

By these operation, when the vehicle turns to the left in the middle rudder angle from 5 degree to 20 degree, the left forward to the vehicle's traveling direction is irradiated using an intermediate distribution pattern either between the distribution pattern shown in FIG. 4A and the distribution pattern shown in FIG. 5A, or between FIG. 4B and 5B. For the low beam, this intermediate distribution pattern is also gradually modified from the distribution pattern shown in FIG. 4A to the distribution pattern shown in FIG. 5A corresponding to the rudder angle is increased. For the high beam, this intermediate distribution pattern is gradually modified from the distribution pattern shown in FIG. 4B to the distribution pattern shown in FIG. 5B corresponding to the rudder angle is increased.

Similarly, when the vehicle turns to the right in the middle rudder angle from 5 degree to 20 degree, the right forward to the vehicle's traveling direction is irradiated using an intermediate distribution pattern either between the distribution pattern shown in FIG. 4A and the distribution pattern shown in FIG. 6A, or between FIGS. 4B and 6B. For the low beam, this intermediate distribution pattern is also gradually modified from the distribution pattern shown in FIG. 4A to the distribution pattern shown in FIG. 6A corresponding to the rudder angle is increased. For the high beam, this intermediate distribution pattern is gradually modified from the distribution pattern shown in FIG. 4B to that of FIG. 6B corresponding to the rudder angle is increased.

As described above, the head light system for a vehicle of the present embodiment is constructed with the plurality of the light units 36L, 36R, 38L, and 38R, which are accommodated within their lamp body 34 at each of the bilateral pair of head lights 10L and 10R which construct the light set 10, and operated the irradiation corresponding to the rudder angle. The irradiation control is operated by the intensity control such that it adjusts irradiation intensity of each of the light units 36L, 36R, 38L, and 38R with these light units 36L, 36R, 38L, and 38R are kept in turn-on status; so that it enables to eliminate the danger such that a driver in an oncoming car and pedestrians falsely recognize that a passing operation is performed and also enable to prevent that inside the lamp body 34 looks partly dark.

Therefore, according to the present embodiment, when a plurality of the light units accommodated in the lamp body controls its irradiation corresponding to the rudder angle, it enables to prevent bothering a driver of an oncoming car with strangeness and also prevent damage on an appearance of light.

Furthermore, according to the present embodiment, when a vehicle goes straight, a ratio of the irradiation intensity of the straight ahead irradiating units 36L and 36R is increased against the left irradiating unit 38L and the right irradiating unit 38R comparing with that of the vehicle turning. Accordingly, a road surface of the vehicle's traveling direction is able to be clearly irradiated in both case that the vehicle goes straight and that the vehicle turns meanwhile the power supply to the whole head light system for the vehicle is prevented from overloading.

Furthermore, according to the present embodiment, the above described irradiation control is operated such that irradiation intensity of each of the light units 36L, 36R, 38L, and 38R are gradually modified in the middle rudder angle region. Accordingly, it enables to more effectively prevent a driver of oncoming car and a pedestrian from being bothered with strangeness.

The intensity control pattern shown in FIG. 7 is adopted to operate the irradiation control corresponding to the rudder angle in the present embodiment. Other intensity control patterns than this may be adopted.

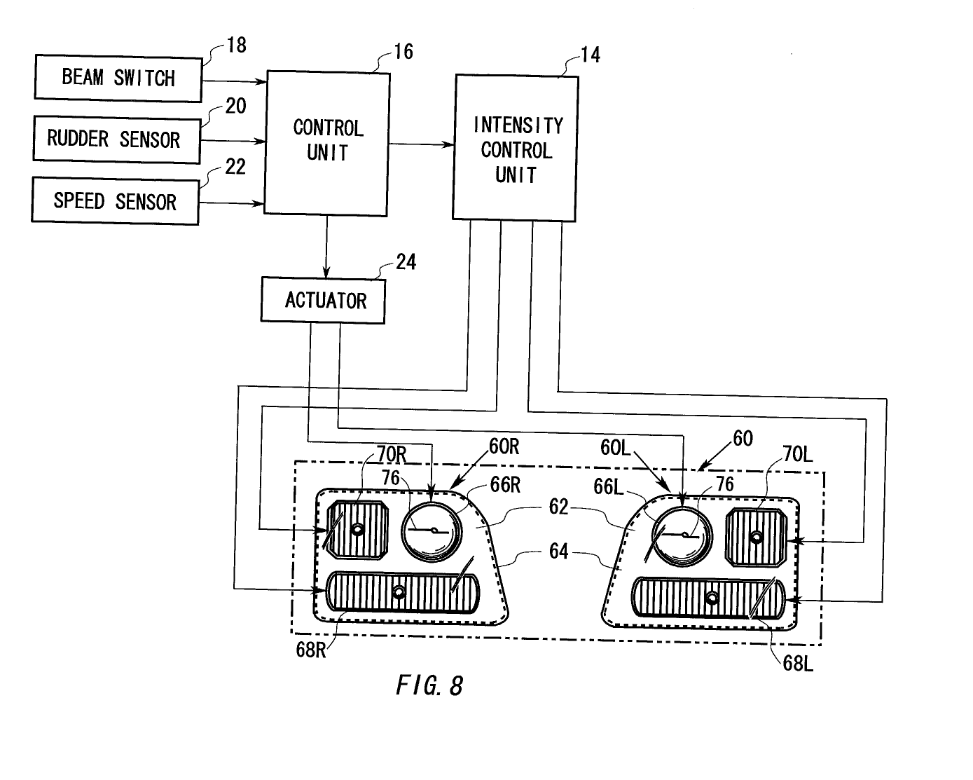

Next, a second embodiment of the present invention will be explained as follows. FIG. 8 shows an outline configuration of ahead light system for vehicles according to the second embodiment.

In FIG. 8, the head light system of the present embodiment for vehicles has a light set 60 which includes a bilateral pair of head lights 60L and 60R provided on the front end of a vehicle, an intensity control unit 14, a control unit 16, a beam switch 18, and a rudder sensor 20 of which are similar to the first embodiment, and a speed sensor 22 and an actuator 24.

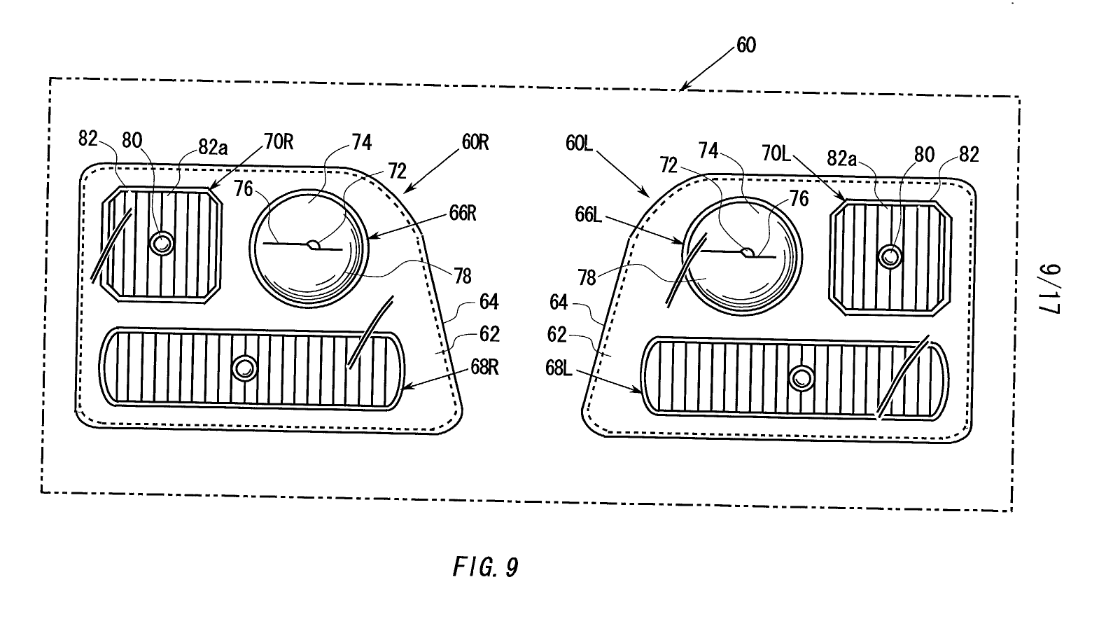

As shown in FIG. 9, the above described light set 60 includes head lights 60L and 60R. For the head lights 60L and 60R, first light units 66L and 66R, second light units 68L and 68R, and third light units 70L and 70R are provided in respective lamp rooms which are formed with plain clear covers 62 and lamp bodies 64, through respective aiming mechanisms not shown. The first light units 66L and 66R, second light units 68L and 68R, and third light units 70L and 70R are provided tiltable in the vertical direction and in the horizontal direction.

Each of the first light units 66L and 66R described above are constructed with a projector type light unit, which includes a discharge bulb (metal-halide bulb) 72, reflector 74 which has a reflection surface formed as a modified ellipsoidal spherical surface, a shade 76, and a condenser lens 78.

The above described shade 76 is movable in the up-down direction, so that its position is able to be converted between a low beam composing position and a high beam composing position which is modified to lower from this low beam composing position. This motion of the shade 76 is driven by the above described actuator 24 made with solenoid and the like; its drive is operated by the control unit 16.

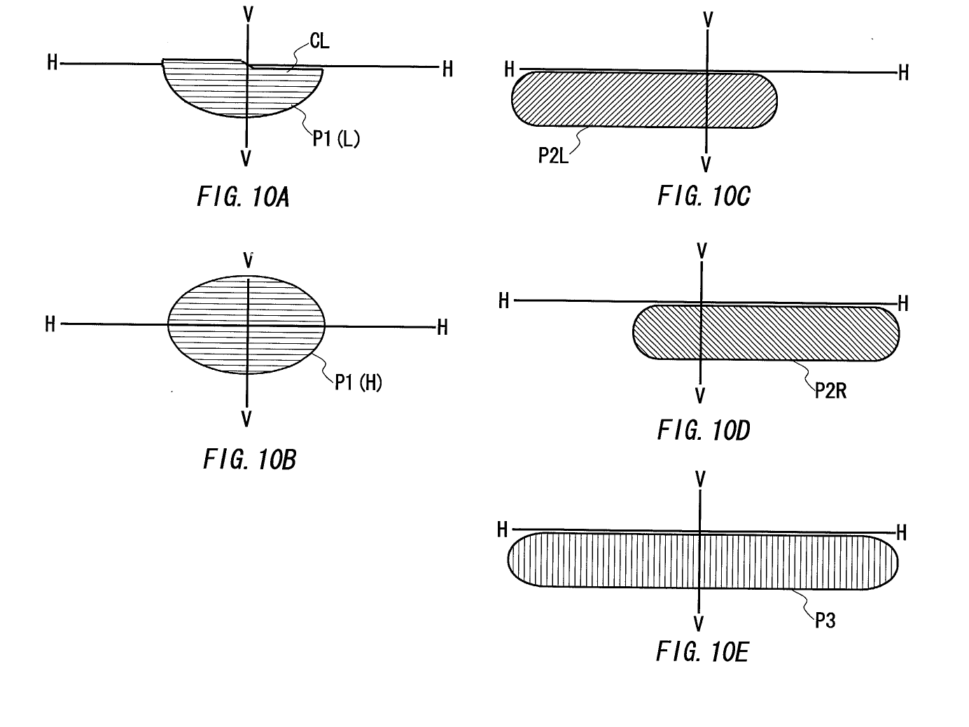

Further, when the above described shade 76 is at the low beam composing position, a distribution pattern for a low beam P1(L) which has a cut off line CL shown in FIG. 10A is formed. When the above described shade 76 is at the high beam composing position, a distribution pattern for a high beam P1(H) shown in FIG. 10B is formed.

A construction of each of the above described second light units 68L and 68R is similar to each of the second light units 38L and 38R in the first embodiment; the second light units 68L and 68R irradiate beams forward to the vehicle with the exactly same distribution pattern as them. That is, the second light unit 68L of the left head light 60L forms a left irradiating pattern P2L as shown in FIG. 10C and the second light unit 68R of the right head light 60R forms a right irradiating pattern P2R as shown in FIG. 10D.

Each of the above described third light units 70L and 70R includes an H7 type (single filament type) halogen bulb 80 and a reflector 82.

Each of the above described reflectors 82 has a reflection surface 82a which is formed with a paraboloid of revolution as a reference surface. Using this reflection surface 82a, light from light sources of the respective halogen bulbs 80 (filaments) is reflected forward with diffusing and deviating, so that an extensive irradiating pattern P3 which has a larger diffusion angle in the right-left direction and directed a little lower than the distribution pattern for a low beam P1(L) or the distribution pattern for a high beam P1(H) as shown in FIG. 10E is formed.

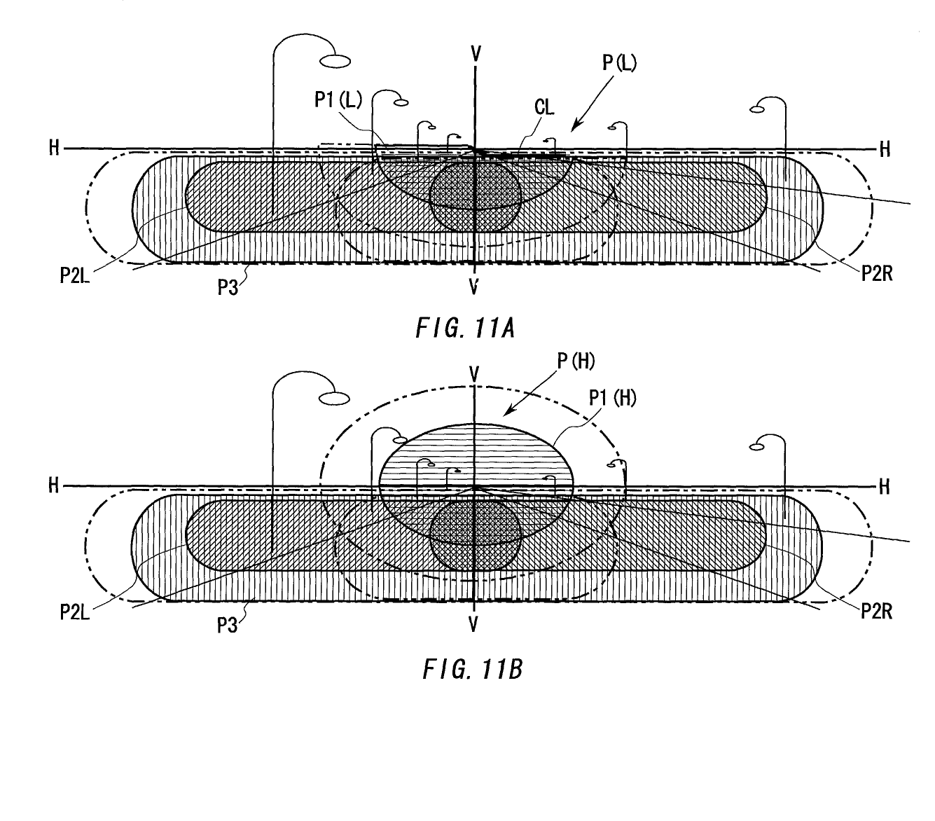

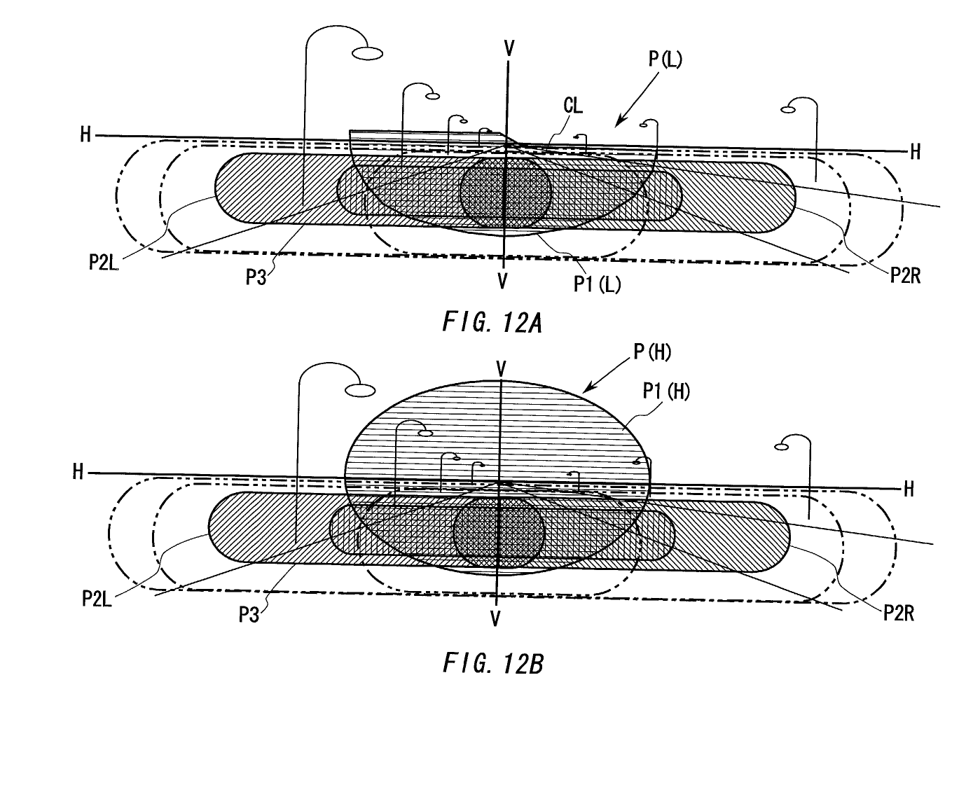

FIGS. 11A to 12B show distribution patterns irradiating forward to a vehicle from the above described light set 10. FIGS. 11A and 11B show distribution patterns when a vehicle goes straight at low speed, and FIGS. 12A and 12B show distribution patterns when a vehicle goes straight at high speed. FIGS. 11A and 12A show a low beam distribution pattern, and FIGS. 11B and 12B show a high beam distribution pattern.

As shown in these figures, a distribution pattern for a low beams distribution pattern P(L) is formed by a superposition of a distribution pattern for a low beam P1(L) by the first light units 66L and 66R, a left irradiating pattern P2L by the left second light unit 68L, a right irradiating pattern P2R by the second light unit 68R, and an extensive irradiating pattern P3 by the third light units 70L and 70R.

In the present embodiment, the first light units 66L and 66R serve as the straight ahead irradiating units (in particular longer distance irradiating units) which irradiates a main part of the distribution pattern for the low beam P(L) and the high beam P(H). The second left light unit 68L serves as a left irradiating unit which irradiates to reinforce the left of the above described main part. The second right light unit 68R serves as a right irradiating unit which irradiates to reinforce the right of the above described main part. Each of the third light units 70L and 70R serves as shorter distance irradiating units (which are also straight ahead irradiating units) which irradiate to reinforce the nearer side of the above described main part.

In the present embodiment, however, as obviously shown in FIGS. 11A to 12B, each of the above described light units 66L, 66R, 68L, 68R, 70L, and 70R are not always operated with the rated power. The irradiation intensity of each of the light units 66L, 66R, 68L, 68R, 70L, and 70R is subjected to the intensity operation. Irradiations are controlled, corresponding to speed of the vehicle and rudder angle.

Here, the irradiation control corresponding to the rudder angle is the same as the first embodiment. Therefore, its description is omitted.

Above described irradiation controls corresponding to the speed are operated as follows. That is, as shown in FIG. 8, a speed signal detected by the speed sensor 22 is sent to the control unit 16. This control unit 16 outputs an intensity control signal corresponding to the speed to the intensity control unit 14.

In the present embodiment, when a beam switching signal is fed from the beam switch 18, the control unit 16 drives the actuator 24 so that it moves the shade 76 of the first light units 66L and 66R to the low beam composing position or to the high beam composing position.

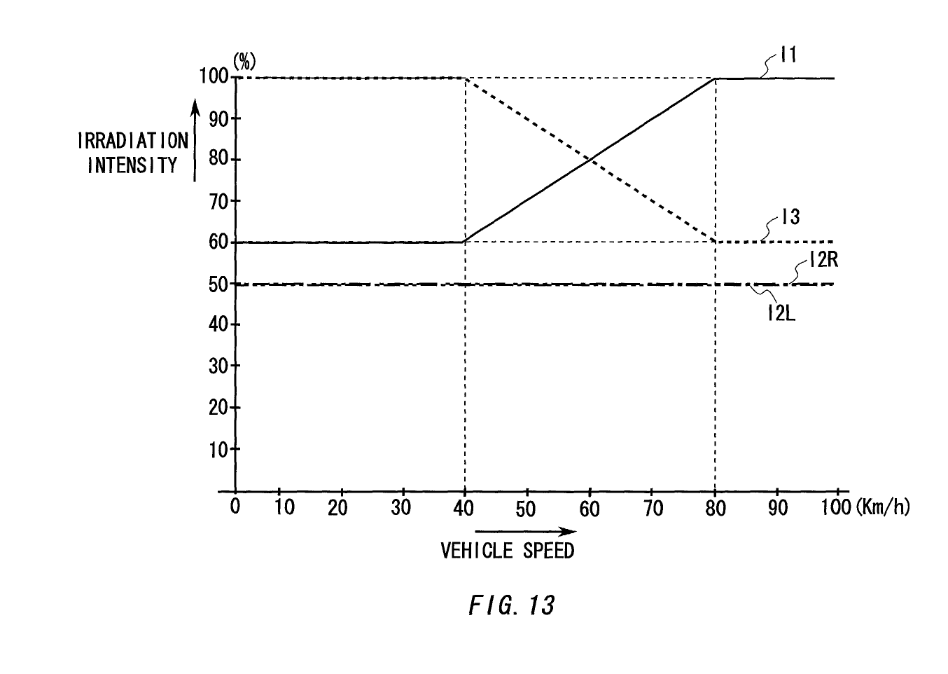

FIG. 13 shows an intensity control pattern in the present embodiment. This intensity control pattern is applied when a vehicle goes straight. Therefore, regardless of the speed, supply power to the second light unit 68L as a left irradiating unit and the second light unit 68R as a right irradiating unit is set at a predetermined value smaller than the rated power so that the irradiation intensity I2L and I2R is 50% of the maximum power.

As shown in FIG. 13, when a vehicle drives at low speed in 0 to 40 km/h, the power supply to each of the first light units 66L and 66R as longer distance irradiating units is set at a predetermined value smaller than the rated power so that its irradiation intensity I1 becomes 60% of the maximum intensity. On the other hand, the power supply to each of the third light units 70L and 70R as shorter distance irradiating units is set at the rated power so that its irradiation intensity I3 becomes the maximum.

FIGS. 11A and 11B show the distribution patterns irradiating forward to the vehicle from the light set 60 under this circumstance. That is, the distribution pattern for a low beam P1(L) and distribution pattern for a high beam P1(H), which irradiates the main part of the low beams distribution pattern P(L) and the high beams distribution pattern P(H), formed by the first light units 66L and 66R becomes a smaller distribution pattern than the pattern shown in FIGS. 10A and 10B, which are shown in FIGS. 11A and 11B in chain double dashed lines. On the other hand, the extensive irradiating pattern P3 formed by each of the third light units 70L and 70R which irradiate to reinforce the nearer side of the above described main part is the same as the distribution pattern shown in FIG. 10E. Thus, when a vehicle drives at low speed, a road surface of the straight forward to the vehicle in the shorter distance is able to be widely irradiated with adequate irradiation intensity.

On the contrary, when a vehicle drives at a high speed over 80 km/h, the power supply to each of the first lights 66L and 66R as longer distance irradiating units is set the same value as the rated power so that its irradiation intensity I1 becomes maximum. The power supply to each of the third light units 70L and 70R as shorter distance irradiating units is set a predetermined value smaller than the rated power so that the irradiation intensity I3 becomes 60% of the maximum.

FIGS. 12A and 12B show distribution patterns irradiating from the light set 60 forward to the vehicle under this condition. That is, the distribution pattern for a low beam P1(L) and the distribution pattern for a high beam P1(H) formed by the first light units 66L and 66R, which irradiate the main part of the low beams distribution pattern P(L) and the high beams distribution pattern P (H), becomes the same distribution pattern shown in FIGS. 10A and 10B respectively. On the contrary, the extensive irradiating pattern P3 formed by the third light units 70L and 70R which irradiate to reinforce the nearer part of the above described main part become a smaller distribution pattern than the pattern shown in FIG. 10E, which is shown in chain double dashed lines in FIGS. 12A and 12B. Thus, when a vehicle drives at high speed, a road surface of the straight forward to the vehicle in the farther distance is irradiated with adequate irradiation intensity.

When a vehicle drives at the middle speed range from 40 to 80 km/h, the power supply control corresponding to speed is operated as follows. As shown in FIG. 13, to each of the third light units 70L and 70R as shorter distance irradiating units, the power supply is gradually decreased as the speed increases such that its irradiation intensity I3 is gradually decreased from 100% to 60%.

To each of the first light units 66L and 66R as longer distance irradiating units, the power supply is gradually increased as the speed increases such that its irradiation intensity I1 is gradually increased from 60% to 100%.

Thus, in the middle speed range from 40 to 80 km/h, it is irradiated with an intermediate distribution pattern either between the distribution pattern shown in FIG. 11A and the distribution pattern shown in FIG. 12A, or between that of FIG. 11B and 12B. Moreover, this intermediate distribution pattern for the low beam is gradually modified from the distribution pattern shown in FIG. 11A to the distribution pattern shown in FIG. 12A as the speed increases. For the high beam, this intermediate distribution pattern is gradually modified from the distribution pattern shown in FIG. 11B to the distribution pattern shown in FIG. 12B as the speed increases.

As described above, in the head light system for a vehicle according to the present embodiment, for each of the a bilateral pair of head light 60L and 60R of the light set 60, a plurality of light units 66L, 66R, 68L, 68R, 70L, and 70R accommodated in its lamp body 64 controls its irradiation corresponding to the speed and the rudder angle. Under these circumstances, all these light units 66L, 66R, 68L, 68R, 70L, and 70R are kept in turn-on status while the intensity controls are achieved by the irradiation intensity of each of the light units 66L, 66R, 68L, 68R, 70L, and 70R. Therefore, it enables to eliminate the danger such that a driver in an oncoming car and pedestrians falsely recognize that a passing operation is performed and also to prevent that inside the lamp body 34 looks partly dark.

Therefore, according to the present embodiment, when a plurality of the light units accommodated in the lamp body is controlled its irradiation corresponding to the speed and the rudder angle, it enables to prevent bothering a driver of an oncoming car and so on with strangeness and also prevents a damage on an appearance of light.

Furthermore, according to the present embodiment, an intensity control such that a ratio of the irradiation intensity of the first light units 66L and 66R as longer distance irradiating units is larger than that of the third light units 70L and 70R as shorter distance irradiating units corresponding to the vehicle's speed-up. Therefore, beams are irradiated with proper distribution pattern suitable for the speed meanwhile the power supply to the whole head light system for the vehicle maybe avoided from overloading.

In the present embodiment as is the case with the first embodiment, when a vehicle goes straight, an intensity control is achieved such that a ratio of the irradiation intensity of the straight ahead irradiating units is increased against the left irradiating unit and the right irradiating unit on the basis when the vehicle turns. Therefore, a road surface of the vehicle's traveling direction is able to be clearly irradiated in both case that the vehicle goes straight and that the vehicle turns meanwhile the power supply to the whole head light system for the vehicle is prevented form overloading.

Furthermore, according to the present embodiment, the above described irradiation control is operated such that irradiation intensity of the light units 66L, 66R, 68L, and 68R are gradually modified in the middle speed region and the middle rudder angle region. Accordingly, it enables to more effectively prevent a driver of oncoming car and a pedestrian from being bothered with strangeness.

The irradiation control pattern shown in FIG. 13 is adopted for the intensity control corresponding to the speed in the present embodiment. It is obvious that other intensity control patterns than this may be adopted.

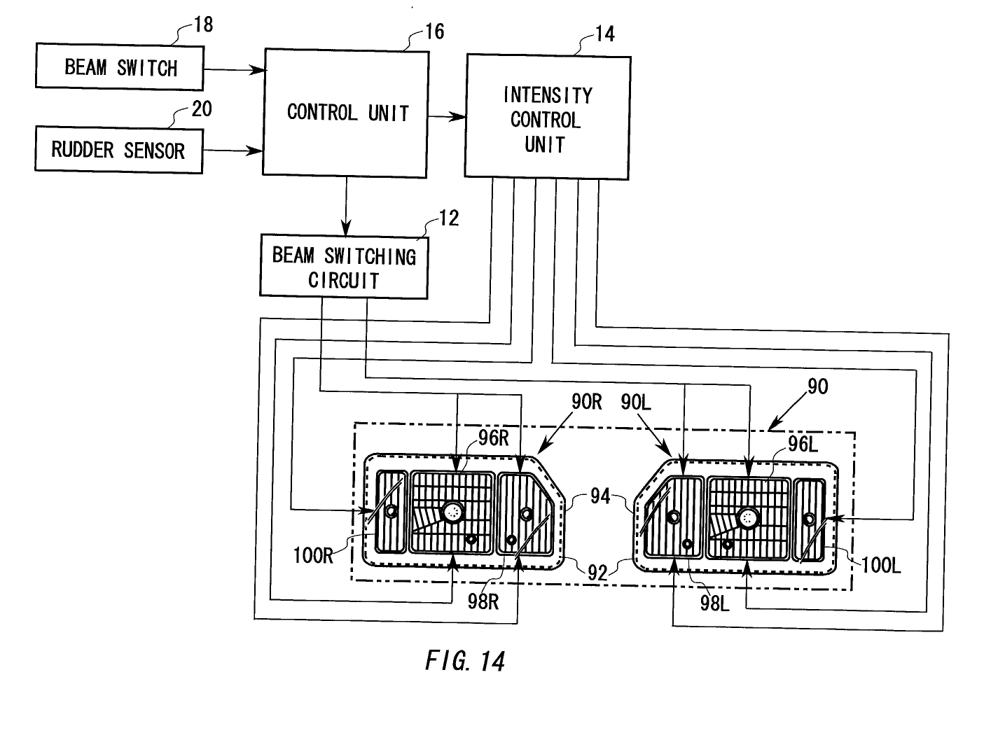

Next, a third embodiment of the present invention will be explained as follows. FIG. 14 shows an outline configuration of a head light system for vehicles according to the third embodiment of the present invention.

The head light system of the present embodiment for vehicles has a light set 90 which includes a bilateral pair of head lights 90L and 90R provided on the front end of a vehicle, a beam switching circuit 12, an intensity control unit 14, a control unit 16, a beam switch 18, and a rudder sensor 20 of which are similar to the first embodiment.

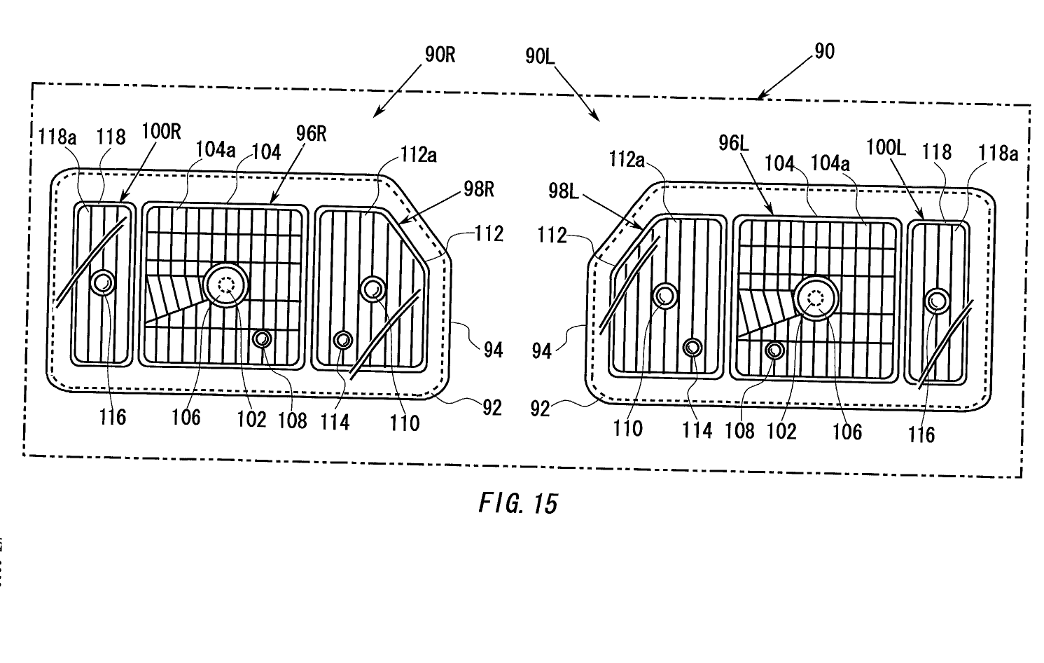

As shown in FIG. 15, for the head lights 90L and 90R of the head light set 60, first light units 96L and 96R, second light units 98L and 98R, and third light units 100L and 100R are provided in respective lamp rooms which are formed with plain clear covers 92 and lamp bodys 94, via respective aiming mechanisms not shown. The first light units 96L and 96R, second light units 98L and 98R, and third light units 100L and 100R are provided tiltable in the vertical direction and in the horizontal direction.

In the present embodiment, the distribution pattern as a whole formed by the light set 90 is similar to the first embodiment. However, the constructions of the light units 96L, 96R, 98L, 98R, 100L, and 100R are different from the first embodiment.

Each of the first light units 96L and 96R has an H7 type (single filament type) halogen bulb 102, a reflector 104, a shade 106, and a small bulb 108.

Each of the above described reflector 104 has a reflection surface 104a which is formed with a paraboloid of revolution as a reference surface. Using the reflection surfaces 104a, light from light sources of the halogen bulbs 102 (filaments) is reflected forward with diffusing and deviating, so that a distribution pattern for a low beam P1(L) which has a cut off line CL as shown in FIG. 3A. The above described small bulbs 108 are substantially always turned on at the rated power at both a high beam mode and a low beam mode.

Each of the above described second light units 98L and 98R has an H7 type (single filament type) halogen bulb 110, a reflector 112, and a small bulb 114.

Each of the above described reflector 112 has a reflection surface 112a which is formed with a paraboloid of revolution as a reference surface. Using the reflection surfaces 112a, light from light sources of the halogen bulbs 110 (filaments) is reflected forward with diffusing and deviating, so that a distribution pattern for a high beam P1(H) which has a cut off line CL as shown in FIG. 3B. The above described small bulbs 114 are also substantially always turned on at the rated power at both a high beam mode and a low beam mode.

Each of the above described third light units 100L and 100R has an H7 type (single filament type) halogen bulb 116 and a reflector 118.

Each of the above described reflector 118 has a reflection surface 118a which is formed with a paraboloid of revolution as a reference surface. Using this reflection surface 118a, light from a light source of the halogen bulb 116 (filament) is reflected forward with diffusing and deviating, so that an third light unit 100L of the left head light 90L forms a left irradiating pattern P2L as shown in FIG. 3C and an third light unit 100R of the right head light 90R forms a right irradiating pattern P2R as shown in FIG. 3D.

The irradiation control of the head light system for a vehicle according to the present embodiment corresponds to the rudder angle and accords to the same distribution pattern as the first embodiment.

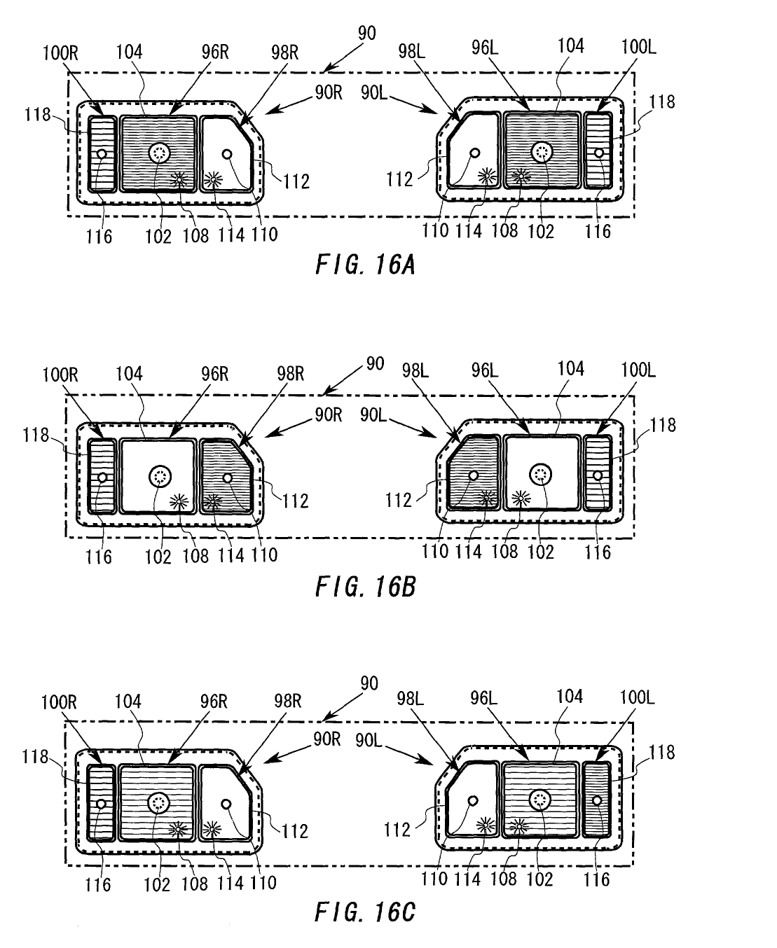

FIGS. 16A to 16C show how each of the light units 96L, 96R, 98L, 98R, 100L, and 100R of the above described light set 90 turns on, viewing from the direction facing to the front of the vehicle.

As shown in FIG. 16A, when the vehicle goes straight and the low beam distribution pattern is irradiating, the halogen bulbs 102 and the small bulbs 108 of the first light units 96L and 96R, the small bulbs 114 of the second light units 98L and 98R, and the halogen bulbs 116 of the third light units 100L and 100R are turned on.

On the other hand, as shown in FIG. 16B, when the vehicle goes straight and the high beams distribution pattern is irradiating, the small bulbs 108 of the first light units 96L and 96R, the halogen bulbs 110 and the small bulbs 114 of the second light units 98L and 98R, and the halogen bulbs 116 of the third light units 100L and 100R are turned on.

Further, as shown in FIG. 16C, when the vehicle turns to the left and the low beams distribution pattern is irradiating, similar to the vehicle going straight, the halogen bulbs 102 and the small bulbs 108 of the first light units 96L and 96R, the small bulbs 114 of the second light units 98L and 98R, and the halogen bulbs 116 of the third light units 100L and 100R are turned on.

These are also the same when the vehicle turns to the right.

However, the above described irradiation control corresponding to the rudder angle, brightness of the halogen bulb 102 of each of the first light units 96L and 96R, brightness of the halogen bulb 116 of each of the third light units 100L and 100R varies among when the vehicle turns to the left, when the vehicle turns to the right, and when the vehicle goes straight. That is, as shown in FIGS. 16A to 16C, the narrower a horizontal hatching applied to each of the reflector 104, 112, and 120 is, the brighter it is lighten.

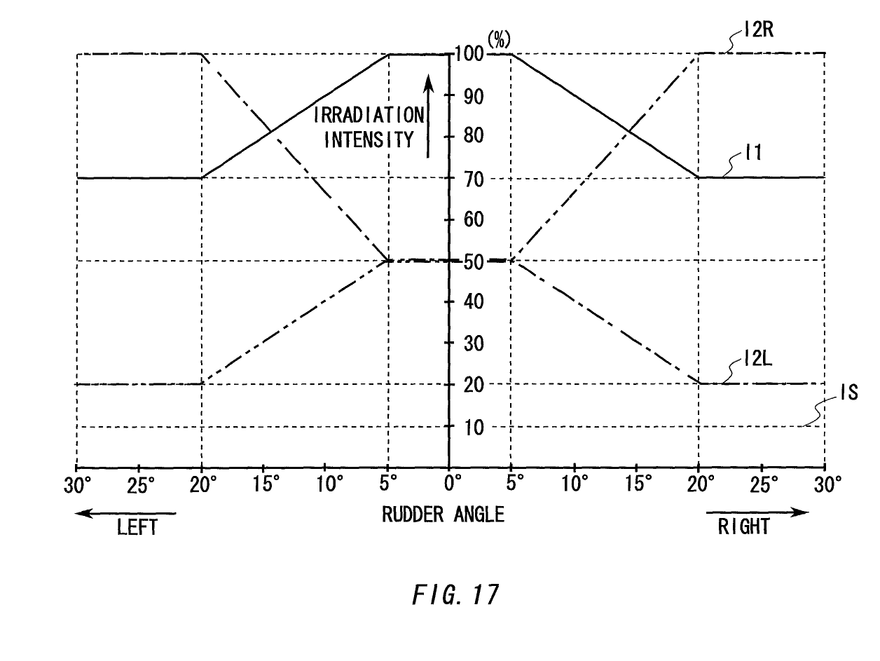

This change of the brightness obeys the irradiation control pattern shown in FIG. 17. The irradiation control pattern shown in FIG. 17 is similar to the pattern shown in FIG. 7, except for the irradiation control for the small bulbs. In the third embodiment, the small bulbs 108, 114 are turned on with the rated power during the irradiation for the light set 90 is controlled. The rated power of the small bulbs 108, 114 is small comparing with the rated power (IS) of the halogen bulbs 102, 110, for instance, 10% of the maximum power of the halogen bulbs, as shown in a chain line of FIG. 17.

In the present embodiment, when the beams are switched from the low beam to the high beam, the halogen bulbs 102 in the first light units 96L and 96R are turned off. On the other hand, when the beams are switched from the high beam to the low beam, the halogen bulbs 110 in of the second light units 98L and 98R are turned off. The small bulbs 108 in the first light units 96L and 96R and the small bulbs 114 in the second light units 98L and 98R are always turned on with the rated power in both light modes for the high beam and the low beam.

Thus, in the present embodiment, all of the above described light units light units 96L, 96R, 98L, 98R, 100L, and 100R are all kept in turn-on status, while irradiation intensity of the light units 96L, 96R, 98L, 98R, 100L, and 100R are able to be adjusted, so that it enables to eliminate the danger such that a driver in an oncoming car and pedestrians falsely recognize that a passing operation is performed and also enable to prevent that inside the lamp body 34 looks partly dark.

Therefore, according to the present embodiment, when a plurality of the light units accommodated in the lamp body are controlled its irradiation corresponding to the rudder angle, it enables to prevent bothering a driver of an oncoming car with strangeness and also prevents a damage on an appearance of light.

In each of the above described embodiments, each of the head lights 10L, 10R, 60L, 60R, 90L, and 90R which constructs the light set 10, 60, and 90 is configured with a plain clear cover 32, 62, and 92; a lens element may be formed on these clear cover 32, 62, and 92, so that a function to deflect and diffuse may be attached.

Furthermore, in each of the above described embodiments, more number of light units may be provided, so that it enables more intensive irradiation control operation.

As described above, a head light system according to the embodiments of the present invention has a plurality of light units accommodated in a lamp body, and its irradiation is controlled with corresponding to a driving condition of the vehicle. These light units are all kept turned on while the above described irradiation control is operated by an intensity control that irradiation intensity of at least one of its light units are adjusted; so that it enables to eliminate the danger such that a driver in an oncoming car and pedestrians falsely recognize that a passing operation is performed and also enable to prevent that inside the lamp body looks partly dark.

Therefore, according to the embodiments of the present invention, when a plurality of the light units accommodated in a lamp body are controlled its irradiation corresponding to the driving condition of the vehicle, it enables to prevent bothering a driver of an oncoming car and so on with strangeness and also prevent damage on an appearance of light.

Adjustment of the irradiation intensity in the above described intensity control may modify the irradiation intensity by stages. If the irradiation intensity is modified gradually in sequence, it enables to more effectively prevent bothering a driver of an oncoming car and so on with strangeness.

In above described construction, light units that is object of the intensity control includes a left irradiating unit and a right irradiating unit. Intensity control is operated such that a ratio of irradiation intensity of the left irradiating unit is increased against the right irradiating unit when the vehicle turns to the left. On the other hand, a ratio of irradiation intensity of the right irradiating unit is increased against the left irradiating unit when the vehicle turns to the right. Thus, a road surface of the vehicle's traveling direction is able to be clearly irradiated when the vehicle turns meanwhile the power supply to the whole head light system for the vehicle is prevented from overloading.

On the other hand, a line of vision of a driver during driving is generally on a road surface in short distance forward to the vehicle when the vehicle is moving at low speed. As the speed of the vehicle increased, the vision line gradually moves to on a road surface in longer distance. Therefore, in the above described embodiments, light units that is object of the intensity control includes a short distance irradiating unit and a long distance irradiating unit; intensity control is operated such that a ratio of irradiation intensity of the long distance irradiating unit is increased against the short distance irradiating unit as the vehicle speeds up. Thus, it irradiates beams with proper distribution pattern suitable for the speed of the vehicle meanwhile the power supply to the whole head light system for the vehicle is kept not to be overloaded.

Furthermore, in above described embodiments, light units that is object of the intensity control includes a straight ahead irradiating unit, a left irradiating unit, and a right irradiating unit; intensity control is operated such that a ratio of irradiation intensity of the straight ahead irradiating unit is increased against the left irradiating unit and the right irradiating unit when the vehicle goes straight on the basis when the vehicle turns. Thus, a road surface of the vehicle's traveling direction is able to be clearly irradiated in both cases when the vehicle goes straight and when the vehicle turns meanwhile the power supply to the whole head light system for the vehicle is prevent from overloading.

Although the present invention has been described by way of exemplary embodiments, it should be understood that those skilled in the art might make many changes and substitutions without departing from the spirit and the scope of the present invention which is defined only by the appended claims.

What is claimed is:

1. A head light system for controlling a distribution pattern based on a vehicle condition, said head light system comprising:
a light set having a variable irradiation intensity;
a lamp body accommodating said light unit; and
a control unit for controlling, based on the condition of the vehicle, the irradiation intensity of said light set while said control unit maintains said light set in a turn-on status.

2. The head light system as claimed in claim 1, wherein said control unit gradually varies the irradiation intensity of said light set.

3. The head light system as claimed in claim 1, wherein said light set includes a left irradiating unit relatively positioned in left of the vehicle and a right irradiating unit relatively positioned in right of the vehicle; and
wherein said control unit relatively increases the irradiation intensity of said left irradiating unit than the irradiation intensity of said right irradiating unit when the vehicle turns to the left, and
said control unit relatively increases the irradiation intensity of said right irradiating unit than the irradiation intensity of said left irradiating unit when the vehicle turns to the right.

4. The head light system as claimed in claim 3, wherein, when the vehicle turns to the left, said control unit makes the irradiation intensity of said right irradiating unit to at least 20% of the maximum irradiation intensity of said right irradiating unit, and
when the vehicle turns to the right, said control unit makes the irradiation intensity of said left irradiating unit to at least 20% of the maximum irradiation intensity of said left irradiating unit.

5. The head light system as claimed in claim 1, wherein said light set includes a short distance irradiating unit and a long distance irradiating unit; and
wherein said control unit relatively increases the irradiation intensity of said short distance irradiating unit than the irradiation intensity of said long distance irradiating unit when the vehicle goes slow, and
said control unit relatively increases the irradiation intensity of said long distance irradiating unit than the irradiation intensity of said short distance irradiating unit when the vehicle goes fast.

6. The head light system as claimed in claim 5, wherein, when the vehicle goes slow, said control unit makes the irradiation intensity of said long distance irradiating unit to at least 60% of the maximum irradiation intensity of said long distance irradiating unit, and
when the vehicle goes fast, said control unit makes the irradiation intensity of said short distance irradiating unit to at least 60% of the maximum irradiation intensity of said short distance irradiating unit.

7. The head light system as claimed in claim 1, wherein said light set includes a straight ahead irradiating unit, a left irradiating unit and a right irradiating unit; and
wherein said control unit relatively increases the irradiation intensity of said straight ahead irradiating unit than the irradiation intensity of said left irradiating unit and the irradiation intensity of said right irradiating unit when the vehicle goes straight,
said control unit relatively increases the irradiation intensity of said left irradiating unit than the irradiation intensity of said straight ahead irradiating unit when the vehicle turns to the left, and
said control unit relatively increases the irradiation intensity of said right irradiating unit than the irradiation intensity of said straight ahead irradiating unit when the vehicle turns to the right.

8. The head light system as claimed in claim 7, wherein said control unit relatively decreases the irradiation intensity of said right irradiating unit than the irradiation intensity of said straight ahead irradiating unit when the vehicle turns to the left, and
said control unit relatively decreases the irradiation intensity of said left irradiating unit than the irradiation intensity of said straight ahead irradiating unit when the vehicle turns to the right.

9. The head light system as claimed in claim 8, wherein, when the vehicle goes straight, said control unit makes the irradiation intensity of said left irradiating unit and said right irradiating unit to at least 50% of the maximum irradiation intensity of said right and left irradiating units,
when the vehicle turns to the left, said control unit makes the irradiation intensity of said right irradiating unit to at least 20% of the maximum irradiation intensity of said right irradiating unit, and
when the vehicle turns to the right, said control unit makes the irradiation intensity of said left irradiating unit to at least 20% of the maximum irradiation intensity of said left irradiating unit.

10. The head light system as claimed in claim 1, wherein said light set includes a main light unit and a small light unit, and said control unit maintains said small light unit of said light set in the turn-on status during controlling the irradiation intensity of said light set.

11. A method for controlling a head light set for a vehicle, comprising the steps of:
dividing a vehicle condition into a first region, a second region and a third region;
in the first region, maintaining an irradiation intensity of the head light set at a first intensity;
in the third region, maintaining the irradiation intensity of the head light set at a third intensity being different from the first intensity;
in the second region, controlling the irradiation intensity of the head light set at a second intensity between the first intensity and the third intensity; and
maintaining the head light set in a turn-on status among the first region, the second region and the third region.

12. The method as claimed in claim 11, wherein, in the second region, the second intensity gradually varies between the first intensity and the third intensity.

13. The method as claimed in claim 11, wherein the vehicle condition is based on a speed of the vehicle.

14. The method as claimed in claim 11, wherein the vehicle condition is based on a rudder angle of the vehicle.
